(19) United States
(12) Patent Application Publication
(10) Pub. No.: US 2016/0045882 A1
(43) Pub. Date: Feb. 18, 2016

(54) NANOFLUID WITH NANOPARTICLE-DECORATED MULTIWALL CARBON NANOTUBES AND METHOD OF PREPARATION THEREOF

(71) Applicant: THE ROYAL INSTITUTION FOR THE ADVANCEMENT OF LEARNING/MCGILL UNIVERSITY, Montréal (CA)

(72) Inventors: Sylvain COULOMBE, Montreal (CA); Jean-Luc MEUNIER, Montréal (CA); Nathan HORDY, Montréal (CA); Larissa JORGE, Montréal (CA); Leron VANDSBURGER, Seattle, WA (US); Phillip ROCHE, Town of Mount Royal (CA)

(21) Appl. No.: 14/776,541

(22) PCT Filed: Mar. 17, 2014
(86) PCT No.: PCT/CA2014/050276

§ 371 Date: Sep. 14, 2015

Related U.S. Application Data
(60) Provisional application No. 61/791,314, filed on Mar. 15, 2013.
(60) Provisional application No. 61/904,264, filed on Nov. 14, 2013.

(51) Int. Cl. B01J 13/00; C09K 5/10

(52) U.S. Cl. CPC B01J 13/0008; C09K 5/10

(57) ABSTRACT

A nanofluid includes a base fluid and multiwall carbon nanotubes (MWCNTs) dispersed in the base fluid. The MWCNTs have an outer surface provided with polar functional groups. The outer surface has decorated portions covered with nanoparticles and undecorated portions where the polar functional groups are exposed. A method prepares a nanofluid. In a first step, MWCNTs are grown on substrates by catalyst-free thermal chemical vapor deposition. In the following step, the MWCNTs' outer surface is functionalized to form polar functional groups covalently bonded thereto. Then, nanoparticles are deposited on the MWCNTs' outer surface such that the outer surface has decorated portions covered with the nanoparticles, while leaving undecorated portions where the polar functional groups are exposed. The resulting nanoparticle-decorated functionalized MWCNTs are then detached from the substrates and dispersed in a base fluid.

### FIELD OF THE INVENTION

The present invention relates to the field of nanotechnology and more particularly concerns a nanofluid containing nanoparticle-decorated multiwall carbon nanotubes (MWCNTs) and a method of preparation thereof.

### BACKGROUND

A variety of industrial, medical and chemical processes require the use of fluid media (solvents) to absorb and transport energy and mass. Although efficient, many technological developments require more from these solvents. By adding surface-stabilized and well-dispersed nanoparticles (NPs) to different solvents, engineered colloidal suspensions, the so-called nanofluids, are being developed with novel properties. Nanofluids have been shown to have higher mass and heat transfer rates, and high and tunable spectral absorptivity over the UV-Visible-Near Infrared ranges.

When developing nanofluids as optically-active fluids, carbon nanotubes (CNTs), including multiwall carbon nanotubes (MWCNTs), offer great advantages due to their intrinsically high broadband absorbance and thermal conductivity, ease of surface functionalization for stabilization, and high aspect ratio. CNTs uniformly and stably dispersed in the nanofluids can then act as volumetrically-distributed supports for different NPs and other complex molecules chosen specifically to impart particular functions or roles to the desired final application. In the prior art, a few nanofluids containing NP-decorated CNTs have been prepared by the mixing of CNT powder with NPs synthesized by laser ablation in water or by chemical reduction of a metal salt in a solution of CNTs. Unfortunately this method does not produce a nanofluid that is stable, and significant agglomeration is often seen after just a few hours.

The challenges to overcome when designing a new nanofluid include 1) stabilizing the dispersed nanoparticles (CNTs included), that agglomerate due to their high surface area, lack of polar chemical groups (such as NH₂, COOH, OH, C═O) and the large van der Waals forces present between the nanoparticles; and 2) using fabrication methods that will not degrade the particles and thus destroy the property which is desired for the nanofluid.

Techniques to stabilize the nanoparticles in a nanofluid have been developed, including, for example, adding ionic surfactants to the solution or wet chemical covalent functionalization. However, both of these approaches require long and tedious preparation steps and/or produce suspensions that are chemically more complex and not stable at high temperatures. Additionally, known techniques used to functionalize CNTs generally involve taking a powder of aggregated CNTs, trying to break apart the aggregates through intense mechanical mixing. However, as a large number of CNTs usually remain aggregated, subsequent treatment leads to selective functionalization of the individual CNT surface area.

There remains a need for a stable nanofluid having improved properties and a simple but robust method of fabricating such a nanofluid.

### SUMMARY

In accordance with a first aspect of the invention, there is provided a nanofluid comprising a base fluid and multiwall carbon nanotubes (MWCNTs) dispersed in the base fluid. The MWCNTs have an outer surface provided with polar functional groups. The outer surface also has decorated portions covered with nanoparticles and undecorated portions where the polar functional groups are exposed.

In one embodiment, the polar functional groups include oxygen-containing functional groups or nitrogen-containing groups.

In another embodiment, the nanoparticles include metal, semiconductor or polymer nanoparticles.

In a further embodiment, the base fluid includes water, at least one polar organic solvent or a mixture of water and at least one polar organic solvent.

In accordance with another aspect of the invention, there is provided a method of preparation of a nanofluid including the following steps:
growing MWCNTs on substrates by catalyst-free thermal chemical vapor deposition (t-CVD);
functionalizing the outer surface of the MWCNTs to form polar functional groups covalently bonded to said outer surface;
depositing nanoparticles on the outer surface of the MWCNTs such that the outer surface has decorated portions covered with the nanoparticles, while leaving undecorated portions where said polar functional groups are exposed, to form nanoparticle-decorated functionalized MWCNTs; and
detaching the nanoparticle-decorated functionalized MWCNTs from the substrates and dispersing thereof in a base fluid.

In one embodiment, the step of growing the MWCNTs by catalyst-free thermal chemical vapor deposition (t-CVD) includes the following steps:
providing stainless steel substrates;
heating the substrates between about 650° C. to about 800° C.; and
exposing the substrates to acetylene whereby the MWCNTs are allowed to grow on the substrates.

In another embodiment, the step of functionalizing the outer surface of the MWCNTs is performed by plasma-functionalization.

In another embodiment, the step of depositing the nanoparticles on the outer surface of the MWCNTs is performed by pulsed laser ablation (PLA).

In another embodiment, the step of depositing the nanoparticles on the outer surface of the MWCNTs is performed by exposing a metal, semiconductor, or polymer target facing the MWCNTs' surface to a pulsed laser beam.

In another embodiment, the step of detaching and dispersing the nanoparticle-decorated functionalized MWCNTs in the base fluid is performed by ultrasonication.

In accordance with a further aspect of the invention, there is provided a nanofluid containing functionalized multiwall carbon nanotubes decorated with nanoparticles, wherein the nanofluid is obtained by the method of the invention.

Other features and advantages of the invention will be better understood upon a reading of embodiments thereof with reference to the appended drawings.

### BRIEF DESCRIPTION OF THE DRAWINGS

FIG. 1A is a graph representing the length distribution of MWCNTs present in a nanofluid according to an embodiment of the invention.

FIG. 1B is a graph representing the diameter distribution of MWCNTs present in a nanofluid according to an embodiment of the invention.

FIG. 2 represents scanning electron microscopy (SEM) and transmission electron microscopy (TEM) images of MWCNTs present in a nanofluid according to an embodiment of the invention, showing the variety of their lengths and structures.

FIG. 3 shows photographs of plasma-functionalized and non-functionalized MWCNTs nanofluids. FIG. 3A shows an aqueous (deionized water) MWCNT nanofluid containing plasma-functionalized MWCNTs and FIG. 3B shows an aqueous MWCNT nanofluid containing MWCNTs which were not plasma functionalized. In both FIGS. 3A and 3B, the MWCNTs concentration is about 0.15 g/L. FIG. 3C shows photographs of nanofluids containing plasma-functionalized MWCNTs in denatured alcohol at different concentrations (0 mg/L, 5 mg/L, 11 mg/L, 18 mg/L, 28 mg/L, 38 mg/L and 53 mg/L) taken 8 months after their preparation.

FIG. 4 shows scanning transmission electron microscopy (STEM) images of gold NP-decorated MWCNTs present in a nanofluid according to an embodiment of the invention (sample Au-300: gold was deposited for 300 s of pulsed laser ablation).

FIG. 5A is an energy dispersive X-ray spectroscopy (EDS) spectrum of gold NP-decorated MWCNTs present in a nanofluid according to an embodiment of the invention (sample Au-300: gold was deposited for 300 s).

FIG. 5B is an X-ray photoelectron spectroscopy (XPS) spectrum of gold NP-decorated oxygen-functionalized MWCNTs present in a nanofluid according to an embodiment of the invention (sample Au-300: gold was deposited for 300 s).

FIG. 6 represents UV-Vis absorbance spectra comparing the absorption of water, of gold nanoparticle-decorated functionalized MWCNTs (absorption due to water removed) and of a gold nanoparticle-decorated functionalized MWCNTs nanofluid (with water) according to one embodiment of the invention. The concentration of the gold nanoparticle-decorated functionalized MWCNTs (Au—F-CNTs) in the nanofluid is 28 mg/L at a gold nanoparticle decoration of 300 seconds.

### DESCRIPTION OF EMBODIMENTS

In accordance with aspects of the invention, there is provided a nanofluid containing NP-decorated multiwall carbon nanotubes (MWCNTs) dispersed in a base fluid, and a method of making such a nanofluid. As will be understood upon a reading of the present description, nanofluids according to embodiments of the invention exhibit long-term stability, heat absorption and other properties suitable for many applications.

Nanofluid Structure and Properties

Generally speaking, a nanofluid consists of a stable colloidal suspension of nanometer-sized particles in a base fluid. In other words, a nanofluid may be defined as a base fluid having nanometer-sized particles uniformly dispersed therein. Nanofluids exhibit enhanced properties with respect to the base fluid, such as higher thermal and mass diffusivities, higher, and possibly selective, gas solubility, and tunable optical absorption coefficient, amongst others. These properties make nanofluids useful in a variety of industrial applications which require the use of fluids to absorb and transport heat and molecules.

Nanometer-sized particles are often defined as particles with at least one dimension below 100 nm. Particles not meeting this threshold, but still of a small enough size to exhibit properties typically associated with nanoparticles, may however still be considered within the scope of the present invention.

The principal nanometer-sized particles dispersed in the base fluid are multiwall carbon nanotubes (MWCNTs). MWCNTs are generally understood to be allotropes of carbon having a cylindrical structure defining an outer surface and an inner surface. MWCNTs have advantageous chemical and physical properties such as high broadband spectral absorptivity, excellent thermal conductivity, ease of surface functionalization, and a large surface over which one can deposit additional sub-entities (e.g. smaller nanoparticles).

The MWCNTs have a broad range of sizes and geometries. They may have structures including straight carbon nanotubes, bamboo-type carbon nanotubes, waved carbon nanotubes, coiled carbon nanotubes and branched carbon nanotubes.

The nanofluids according to some embodiments of the invention contain MWCNTs having a diameter ranging between about 15 and about 100 nm. In another embodiment, the MWCNTs diameter distribution is characterized by a mean diameter ranging from about 30 to about 40 nm. The MWCNTs have a broad length distribution, for example ranging from about 100 nm to about 10 μm, with an average around 1.25 μm.

The term “about”, as used herein before any numerical value, means within an acceptable error range for the particular value as determined by one of ordinary skill in the art. This error range may depend in part on how the value is measured or determined, i.e. the limitations of the measurement system. It is commonly accepted that a 10% precision measure is acceptable and encompasses the term “about”.

In accordance with embodiments of the invention, the MWCNTs are functionalized so as to include polar functional groups on their outer surface. The polar functional groups generally contain oxygen and/or nitrogen. They can be neutral or ionized groups. The polar groups on the surface of the MWCNTs will enhance their dispersibility into polar solvents such as water, ethanol, methanol, denatured alcohol, glycols etc. . . . . When the polar groups specifically interact with water, they may also be referred to as hydrophilic groups.

In some implementations, the MWCNTs may have been functionalized on their outer surface by plasma functionalization, as will be explained in further detail below. In another embodiment, the polar functional groups are oxygen- or nitrogen-containing functional groups. Oxygenated functional groups include carboxyl, hydroxyl and carbonyl groups. Nitrogen-containing functional groups include amine and amide functional groups. These polar groups are covalently bonded to the outer wall of the MWCNTs.

The presence of polar functions on the surface of the MWCNTs enhances their miscibility with polar solvents such as water or other polar organic chemicals, thus limiting the direct CNT-CNT interactions. Moreover, when the functionalized MWCNTs are placed in a polar-protic solvent, deprotonation of the carboxyl/hydroxyl groups and protonation of the amine/amide groups can lead to a negatively or positively charged MWCNT surface, generating a repulsive force between individual MWCNTs, and thereby limiting agglomeration.

The outer surface of the MWCNTs is also further provided with decorated and undecorated portions. The decorated portions are portions of the MWCNTs' outer surface which are covered with nanoparticles (NPs). The undecorated portions are portions of the MWCNTs' outer surface wherein the polar functional groups resulting from the plasma functionalization are exposed, i.e. the polar groups are in direct contact with the base fluid. The NPs, which may be amorphous or crystalline, confer additional and localized chemical and physical properties to the supporting MWCNTs without destabilizing the suspension.

In an embodiment, the nanoparticles which cover the MWCNTs' outer surface may be metal nanoparticles, such as transition metal nanoparticles. Preferred transition metal nanoparticles include gold (Au), nickel (Ni), iron (Fe), chromium (Cr), cobalt (Co), copper (Cu), silver (Ag), titanium (Ti), and platinum (Pt) nanoparticles. Gold and platinum nanoparticles are preferred nanoparticles. Metal oxide nanoparticles are also encompassed in the group of metal nanoparticles.

In an alternative embodiment, the nanoparticles which cover the MWCNTs' outer surface may be semi-conductor nanoparticles such as, for example, cadmium selenide (CdSe) nanoparticles.

Other nanoparticles may be polymer nanoparticles, for example polystyrene or polypyrrole.

In an embodiment, the nanoparticle size ranges between about 1 and about 60 nm. In another embodiment, most of the NPs have a diameter which is less than about 5 nm. NPs with small size can be advantageous since they offer the largest specific surface area and minimize the use of the MWCNT surface.

The MWCNTs decoration level, which can be defined as the fraction of the total surface area of the MWCNTs which is covered by NPs, ranges from a minimum decoration level to a maximum decoration level for which the nanofluid can perform to its designed intent while avoiding destabilization. This destabilization of the nanofluid will occur when too large a fraction of the stabilizing polar functions loses contact with the base fluid.

In another embodiment, the decorated and undecorated portions are distributed on the outer surface of the MWCNTs in such a way that the NPs and exposed polar groups are available over the entire surface.

The nanofluid requires a base fluid in which the functionalized MWCNTs can be dispersed. A polar base fluid provides a better dispersibility. Preferably, the base fluid is a polar solvent chosen from water and polar organic solvents such as ethylene glycol, propylene glycol, isopropanol, ethanol, methanol or denatured alcohol, to name a few. The base fluid may also be a mixture of polar organic solvents or a mixture of water with at least one polar organic solvent. Deionized or reverse osmosis water may preferably be used as the base fluid for biological applications.

The concentration of NP-decorated MWCNTs in the nanofluid may be up to about 1.0 g/L. In an embodiment, the concentration of NP-decorated MWCNTs in the nanofluid may be up to about 0.150 g/L. In another embodiment, the nanofluid contains from about 0.005 to about 0.01 g/L NP-decorated MWCNT.

In the nanofluid, polar functional groups remain accessible at the surface of the MWCNTs despite the co-existence of the NP-decorated portions. Thus, once the MWCNTs are added to the base fluid, the polar groups can be in direct contact with the base fluid, thus increasing dispersibility of the MWCNTs in the nanofluid. When the dispersibility of the MWCNTs is optimal, one can say that the MWCNTs are “homogeneously” dispersed in the base fluid. One can also refer to a mono-disperse nanofluid. The NP-decorated functionalized MWCNTs do not settle out of the fluid (they do not aggregate) over an extended period of time at the required working temperature and the nanofluid can be qualified as being “stable”.

In the context of the invention, the “stability” of the nanofluid thus refers to the period of time during which the MWCNTs remain dispersed in the base fluid at the required working temperature, i.e. the period of time during which the MWCNTs do not settle out of the fluid. The stability of the nanofluid will depend on the decoration level at the surface of the MWCNTs, but also on the nature of the base fluid. At the lowest decoration level, stability over time will be increased due to the availability of the polar groups at the surface of the MWCNTs. Moreover, stability over time can be increased with solvents such as ethylene glycol, polyethylene glycol or denatured alcohol compared to water due to various fluid properties such as viscosity, pH, polarity etc.

The required stability of the nanofluid will depend on its intended application. For some applications the nanofluid will only need to be stable for a few weeks while it can be preferable that the nanofluid be stable for months or even years in other applications. For the context of this invention, a nanofluid is classified as stable if the absorptivity of the non-agitated nanofluid, as quantitatively determined by absorption spectroscopy, decreases by less than about 15% over the required period of time at the required working temperature, although specific stability requirements will vary with the application.

Nanofluids are best known for heat transfer enhancements. They can be used in many applications including, for example, forced convection in pipes, pool boiling and heat pipes. Nanofluids according to embodiments of the invention may be useful for known applications of such substances, and may provide improved performances in some cases. Furthermore, the advantageous properties of nanofluids according to embodiments of the invention can open the door to new applications.

Method of Preparation of a Nanofluid

In accordance with another aspect of the invention, there is provided a method of preparation of a nanofluid containing nanoparticle-decorated functionalized multiwall carbon nanotubes (MWCNTs). The method includes the following steps:
growing MWCNTs on substrates by catalyst-free thermal chemical vapor deposition (t-CVD);
functionalization the MWCNTs for forming covalently bonded polar functional groups to their outer surface;
deposition of nanoparticles on the outer surface of the MWCNTs, thereby forming NP-decorated functionalized MWCNTs with remaining accessible polar functional groups; and
detaching the NP-decorated functionalized MWCNTs from the substrates and dispersing thereof in a base fluid.

A particular feature of this method is that the functionalization step and nanoparticles deposition step occur while the grown MWCNTs are still anchored to the substrates used for the thermal chemical vapor deposition. The MWCNTs are only detached from the substrate in the last step of the process of making the nanofluid. As explained in more details below, this feature allows obtaining individual MWCNTs with a highly functionalized surface and a better distribution of the nanoparticles over the MWCNTs' surface.

The first step for preparing the nanofluid consists of the synthesis of the MWCNTs by thermal chemical vapor deposition.

In an embodiment, the MWCNTs are synthesized by catalyst-free thermal chemical vapor deposition (t-CVD) using acetylene gas (C₂H₂) as the carbon source. Stainless steel substrates, such as stainless steel meshes or flat sheets, are positioned in a quartz tube which is placed in a furnace wherein the substrates are brought to about 650 to about 800° C., preferably about 700° C. Then, the substrates are exposed to acetylene and the MWCNTs are allowed to grow on the substrate. The acetylene concentration and injection time are adjusted to allow growth of the MWCNTs on the substrate. In an embodiment, MWCNTs can be grown by injecting acetylene at a flow rate of about 68 standard cubic centimeters per minute (sccm) for about 1 to 5 minutes. MWCNTs covering the entire mesh are obtained at the end of this first step.

The stainless steel substrates used to grow the MWCNTs are preferably stainless steel meshes of the 400 series, such as for example stainless steel 304 or 316 square meshes (4 cm², approximate composition: 67 wt % Fe, 17 wt % Cr, 12 wt % Ni, 2 wt % Mo, 2 wt % others). During the heating process, chromium migrates to the surface of the substrate causing the roughness of the surface to increase drastically. This surface break-up generates small particle-like sites of exposed iron, from which the MWCNTs can precipitate once the meshes are exposed to carbon.

As previously mentioned, other stainless steel substrates, such as flat sheets can also be used to grow MWCNTs. With such stainless steel flat sheets, an etching pre-treatment is preferably required to remove a thick oxide layer prior to growth.

The acetylene flow rate and stainless steel mesh size may be adjusted to the size of the quartz tube. A person skilled in the art would readily appreciate the specific impact of the acetylene flow on mesh size and the resulting density of MWCNTs growth. For instance, an acetylene flow rate of 68 standard cubic centimeters per minute (sccm) and a mesh size of 4 cm² will be efficient for a quartz tube being 5.5 cm in diameter.

The so-produced MWCNTs protrude radially outwards from the grid bars of the mesh and are typically from about 15 nm to about 100 nm in diameter and from about 1 μm to about 10 μm, preferably from about 4 μm to about 6 μm, in length. No additional purification step is required as no amorphous carbon or catalytic particles are produced. The graphitic walls of the MWCNTs which are obtained may present different shapes, including for example straight carbon nanotubes, bamboo-type carbon nanotubes, waved carbon nanotubes, coiled carbon nanotubes, branched carbon nanotubes, candy-cane like bent tips, as shown in FIG. 2. It is also worth noting that carbon nanofibers may also be present in small numbers among the MWCNTs.

The MWCNTs obtained at the end of the first step exhibit hydrophobic characteristics. Hence, such pure CNTs will not be well-dispersed in a polar solvent as they will rather tend to agglomerate and settle.

The second step of the method of preparation of the nanofluid aims to change the surface chemistry of the MWCNTs to allow them to be efficiently dispersed in the polar base fluid upon mixing. For this purpose, the outer surface of the MWCNTs is functionalized with polar functions.

The person skilled in the art would know the methods for functionalizing MWCNTs with polar functions, such as dry and wet functionalization techniques.

In an embodiment, the outer surface of the MWCNTs is plasma-functionalized by exposure to a radio-frequency glow discharge plasma using a Ar/C₂H₆/O₂ mixture, thus allowing the formation of covalently-bonded polar functional groups (e.g., carboxyl, hydroxyl, carbonyl groups) to the outer surface of the MWCNTs.

This plasma functionalization can be performed by a radio-frequency (RF, 13.56 MHz) glow discharge plasma at 20 W in a vacuum chamber set at 2 Torr and filled with oxygen (5 sccm), ethane (1 sccm) and argon (500 sccm). The treatment time can vary between about 1 to about 20 minutes. In some cases a treatment time as short as about 1 minute may be sufficient to obtain the desired functional groups on the MWCNTs' outer surface. The vacuum chamber may be a quartz tube which can be the same as, or different than, the tube used for growing the CNTs. A person skilled in the art will be able to adapt the plasma conditions (power, flowrates, pressure, treatment time) to obtain a high degree of surface functionalization in various types of glow discharge plasma.

This plasma treatment generates carboxyl functional groups (COON), hydroxyl groups (OH) and carbonyl groups (C═O) on the MWCNTs' outer surface.

In another embodiment, the MWCNTs can be plasma-functionalized in the presence of NH₃ instead of O₂ to generate amine and amide functional groups on the MWCNTs' outer surface.

During the functionalization step, the MWCNTs are still anchored to the growth surface (grid bars of the stainless steel mesh) and separated enough to allow a functionalization of the entire surface. Moreover, the grown MWCNTs present defects on their surface that are prime sites to add functional groups. Functionalization of the MWCNTs while they are still anchored to the growth surface allows a uniform functionalization of the entire surface of the MWCNTs compared to functionalization of a powder of aggregated MWCNTs. This results in a nanofluid with improved stability, as well as improved absorption and heat treat transfer properties, as the nanofluid contains suspended individual CNTs instead of agglomerates.

The next step for the preparation of the nanofluid involves the deposition of NPs on the outer surface of the plasma-functionalized MWCNTs. This step can also be named “decoration step”. This allows obtaining NP-decorated functionalized MWCNTs which will be dispersed in the last step for forming the nanofluid.

As previously mentioned, the NPs which decorate the outer surface of the MWCNTs can be metal nanoparticles such as transition metal nanoparticles, including gold (Au), nickel (Ni), iron (Fe), chromium (Cr), cobalt (Co), copper (Cu), silver (Ag), titanium (Ti) and platinum (Pt) nanoparticles. Gold and platinum nanoparticles are preferred noble metal nanoparticles.

In an alternative embodiment, the nanoparticles that cover the MWCNTs' outer surface may be composed of a semiconductor material, such as CdSe. Other nanoparticles may be polymer nanoparticles, for example polystyrene or polypyrrole nanoparticles.

Decoration of the functionalized MWCNTs with metal nanoparticles can be performed by pulsed laser ablation or thermal evaporation/inert gas condensation. Deposition of semiconductor nanoparticles and polymer nanoparticles is generally performed by pulsed laser ablation (PLA).

When deposition of NPs is performed by pulsed laser ablation, a pulsed laser beam is focused on a target (metal, semiconductor, or polymer) causing immediate vaporization of the material and formation of a high-density vapor plasma plume in rapid expansion. In an embodiment, the laser pulse duration is about 5 ns and the laser fluence is about 1 J/cm². Supersaturation of the material vapor plume upon cooling in the buffer background gas leads to homogeneous nucleation followed by nanoparticle formation. The buffer gas pressure is used to control the nanoparticle size. In an embodiment, the buffer gas pressure can be readily adjusted to control the mean nanoparticle size between about 5 and about 60 nm.

In an embodiment, gold NPs are deposited on the MWCNTs' outer surface. The deposition of gold NPs is performed by ablation of a gold target, preferably 100% pure gold target, using a focused high energy pulsed Nd:YAG laser beam in a vacuum chamber at a set pressure of about 1 mTorr to about 4 Torr, preferably about 1 mTorr (laser wavelength: 355 nm, laser fluence: 1.2 J/cm²).

The deposition treatment is carried out during a predetermined time allowing the formation of the NPs on portions of the outer surface of the MWCNTs, while some other portions of the MWCNTs' surface contain accessible polar functional groups. The skilled person in the art will be able to determine the required time for depositing the desired amount of NPs at the MWCNTs outer surface. In the embodiment where the MWCNTs are decorated with gold NPs, gold deposition is preferably carried out for about 180 to about 600 seconds. However, the time during which NPs deposition is carried out will depend on the laser power and repetition rate. The skilled person in the art will be able to determine the time deposition to obtain the required decoration level.

The chamber pressure at which deposition is performed may affect the size of the NPs formed. Hence, the skilled person in the art will be able to determine the pressure to be applied for obtaining the desired NPs size. Small size NPs may be obtained at low pressure. In the embodiment where the MWCNTs are decorated with gold NPs, the gold deposition is carried out at a pressure of 1 mTorr and the gold NPs produced may have a nominal size as little as about 1 nm.

The decoration step (deposition of NPs on the MWCNTs' surface) is also performed while the MWCNTs are still anchored to the growth surface (grid bars of the stainless steel mesh). The incoming stream of nanoparticles produced by pulsed laser ablation is generally directed so as to treat one side of the mesh. Since the MWCNTs are not agglomerated and are separated enough from each other, this allows depositing the NPs substantially all over the surface of the MWCNTs facing the incoming stream of nanoparticles.

The last step of the method is to obtain the nanofluid itself by dispersing the functionalized NP-decorated MWCNTs resulting from the previous step in a base fluid. In this step, the NP-decorated functionalized MWCNTs which are still attached to the stainless steel mesh substrate where the CNTs have grown are also detached there from.

The base fluid is usually a polar base fluid to provide a better dispersibility of the MWCNTs. Preferably, the base fluid is a polar solvent chosen from water and polar organic solvents such as ethylene glycol, propylene glycol, isopropanol, ethanol, methanol or denatured alcohol, to name a few. However, the base fluid can also be a mixture of polar solvent or a mixture of water with at least one polar organic solvent.

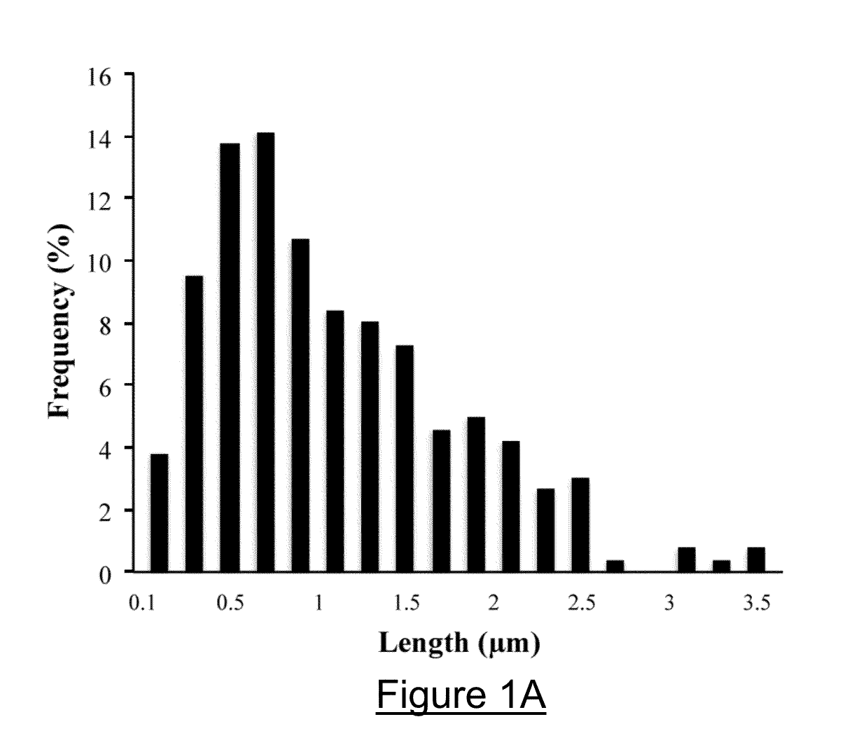

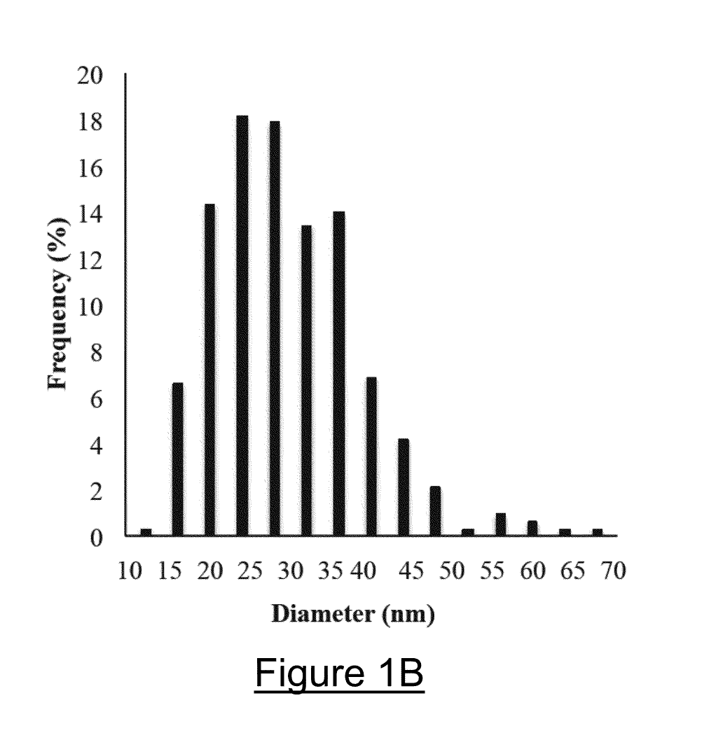

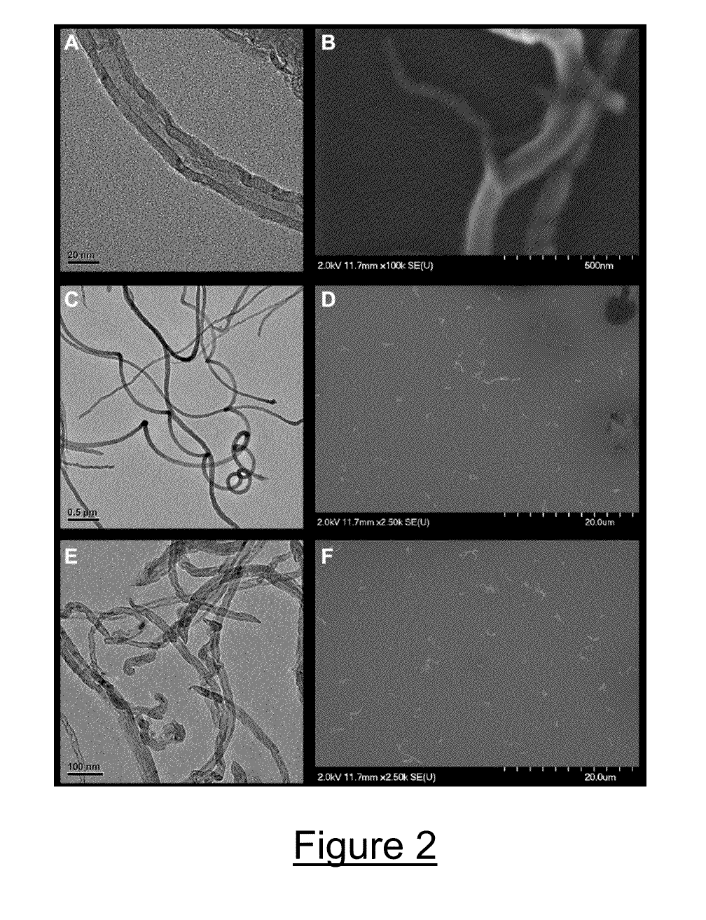

This step thus involves placing the substrate in the base fluid under ultrasonication, for example using an ultrasonic bath or probe. The MWCNTs are broken off near their base (they are not uprooted) and dispersed in the fluid. During ultrasonication, some of the NP-decorated functionalized MWCNTs are also broken into fragments having a smaller length than the initial grown MWCNTs (before being detached from the substrate). In the suspension, the NP-decorated functionalized MWCNTs have a broad length distribution ranging from about 100 nm to about 10 μm. This length distribution is substantially Gaussian in nature as can be seen in FIG. 1A which represents a graph of the length distribution of gold nanoparticle-decorated plasma-functionalized MWCNTs fragments after sonication. The graph shows a Gaussian with a positive skew. Some fragments can remain large after sonication (up to 10 μm) and fragments as small as about 100 nm are also observed. It should be noted that although the graph stops after 3.5 μm, MWCNTs with a length up to 10 μm are still present after sonication. However, these larger MWCNTs are not included on the graph as they occur in too low of a frequency (about <0.5% per micron). In this particular embodiment, the mean length of the MWCNTs is about 1.25 μm and median is about 1.07 μm. The maximum frequency is around 0.75 μm, due to the positive skew.

As previously mentioned, the diameter of the MWCNTs may range from about 15 to about 100 nm. As can be seen in FIG. 1B, which represents a graph of the diameter distribution of gold decorated plasma-functionalized MWCNTs fragments, the diameter distribution of the MWCNTs is substantially Gaussian in nature.

The concentration of the NP-decorated functionalized MWCNTs in the nanofluid may be up to about 1.0 g/L. In other words, it is possible to obtain a mono-disperse nanofluid with a concentration of MWCNTs up to about 1.0 g/L of the fluid. The concentration of the MWCNTs in the nanofluid will be adapted depending on the intended application.

In accordance with another aspect of the invention, there is provided a nanofluid containing functionalized multiwall carbon nanotubes (MWCNTs) decorated with nanoparticles, obtained by the above-described method.

The resulting nanofluid is stable for an extended period of time and towards heating at high temperatures. Thanks to the accessible polar functional groups on the surface of the decorated MWCNTs, it is possible to obtain a dispersion which remains homogeneous during a required period of time. With these properties, the nanofluid may find applications in a variety of industrial processes which require the use of fluids to absorb and transport energy and/or molecules. Alternatively, the nanofluid of the invention may be used as a starting material to prepare other nanofluids wherein the MWCNTs can be further modified for specific applications or to prepare bulk solids and films of polymer-based nanocomposite materials.

### Example

### Synthesis of MWCNT

1. Stainless steel 316 square meshes (4 cm², approximate composition: 67 wt % Fe, 17 wt % Cr, 12 wt % Ni, 2 wt % Mo, 2 wt % others) were sonicated in acetone for 30 minutes. This step ensures the removal of contaminants or grease put on the sample during prior manipulations.
2. Using tweezers, the disks were removed from the acetone and left to dry in ambient air for 30 seconds.
3. The square meshes were then placed in a ceramic boat (3.5×6 cm²). This boat was positioned in the middle of a 1.22 m long, 5.5 cm diameter, quartz tube which is itself placed inside a tubular furnace. After closing both ends of the quartz tube, an oxygen purge was done using argon (600 standard cubic centimetres per minute (sccm)) for 20 minutes. This is to prevent undesirable reactions of acetylene (the carbon source for production of CNTs) with oxygen.
4. The furnace was turned on and the temperature was set to 700° C. This temperature ensures that the mesh undergoes phase transformation and recrystallization of the grains in order to form favorable growth sites for the CNTs.
5. After exposing the mesh in the furnace for 30 minutes at 700° C., acetylene (68 sccm) was injected for 5 minutes. Given the size of the quartz tube, an acetylene flow rate of 68 sccm provides a sufficient quantity of acetylene for dense growth of CNTs on the mesh.
6. The furnace was then shut down and left to cool.

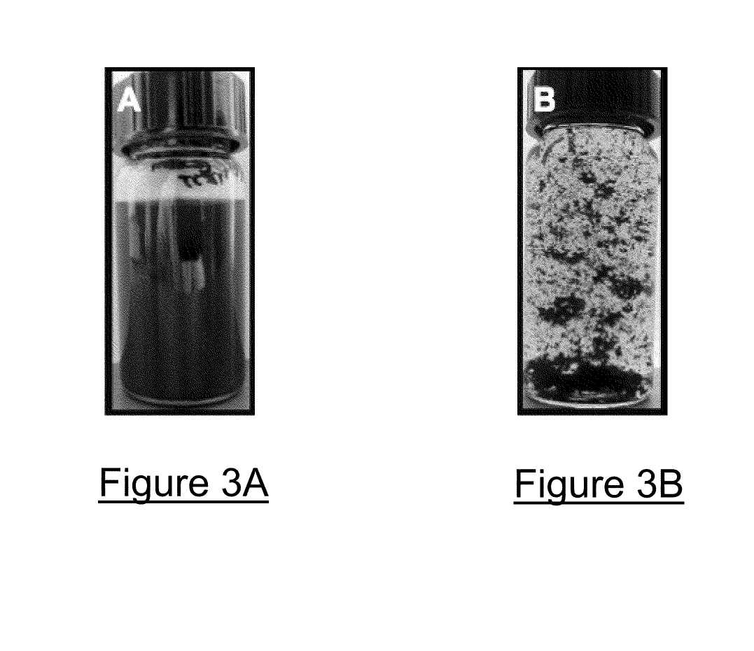

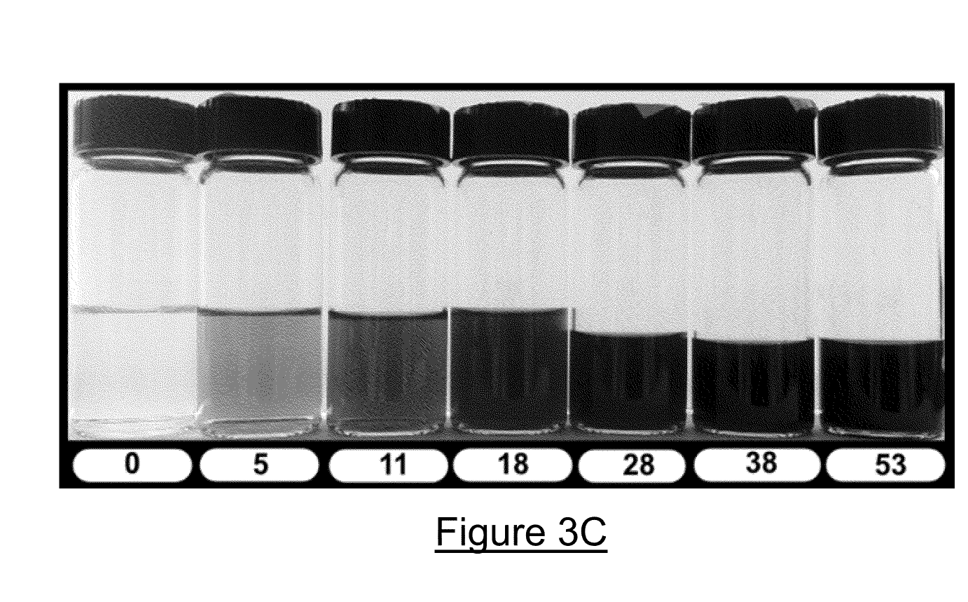

Plasma Functionalization
MWCNTs were put back inside the quartz tube (note that after MWCNT synthesis, the tube is cleaned with acetone and is heated to 700° C. in air for removal of any carbon residues). The tube was pumped down to a base pressure of 10 mTorr. Two copper electrodes were mounted on the tube, 7 cm apart, on each side of the MWCNT sample. The tube was then filled with oxygen (5 sccm), ethane (1 sccm) and argon (500 sccm) and set to a pressure of 2 Torr. Using a radio-frequency (RF, 13.6 MHz) generator equipped with a matching network, a glow discharge plasma at 20 Watt is generated to treat the samples for 10 minutes (note that the samples are positioned inside the glow discharge). Plasma treatment generates significant carboxyl groups upon the surface of the MWCNTs that create the potential for forming substantially mono-disperse nanofluids as shown in FIG. 3.
FIG. 3 shows photographs of plasma-functionalized and non-functionalized MWCNTs nanofluids. FIG. 3A shows the aqueous nanofluid containing plasma-functionalized MWCNTs. FIG. 3B shows the aqueous nanofluid containing MWCNTs which were not plasma functionalized. Unmodified MWCNTs (FIG. 3B) which lack oxygen-containing functional groups on their surface show poor interaction with and dispersibility in polar solvents, thus they form aggregates in the aqueous solution. Thanks to the polar groups on their surface which interact with water, plasma-functionalized MWCNTs are well dispersed in the nanofluid (FIG. 3A). Solutions containing functionalized MWCNTs are monodisperse even with increasing MWCNTs' concentrations (FIG. 3C). The resulting solutions are stable over extended periods of time (FIG. 3C, taken after 8 months).

Gold Nanoparticle Synthesis and Deposition
1. The samples consisting of plasma-functionalized MWCNTs grown on the stainless steel 316 mesh were then transferred to a stainless steel vacuum chamber (6 way-cross, 6¼″ outer diameter sphere body). Samples were positioned 5 cm away from the 100% pure gold target. The target and the samples were parallel to each other to increase the proportion of gold nanoparticles being deposited. Due to the geometry of the sample holder, only half of the sample area was exposed for gold deposition.
2. After pumping down the chamber for 30 minutes to remove a maximum of gas contaminants (chamber pressure is 1 mTorr), a focused high energy pulsed Nd:YAG laser beam (laser wavelength: 355 nm, laser fluence: 1.2 J/cm², laser pulse duration: 5 ns, pulse frequency: 10 Hz) was shined at a 45° angle on the gold target. The evaporated gold forms an expanding plume where gold nanoparticles (NPs) are formed upon super-saturation of the metal vapour cloud. Gold was deposited for 240 or 300 seconds (these samples are referred to as Au240 and Au300). During ablation, the target was moved vertically at a speed of 6 mm/min. This was done to avoid formation of deep holes on the target surface which lead to increased re-deposition of ablated material on the sides of the ablation site. Given the traveling range limits of the step motor, the same area on the gold target was ablated twice for production of sample Au240 and three times for Au300. The pressure inside the chamber affects the size of the NPs formed. The size distribution of NPs ranges from about 1 to 25 nm. The low pressure chosen for deposition of gold allowed for production of the very small NPs with nominal size of 1 nm.

Making Nanofluid
Each sample consisting of gold NP-decorated plasma-functionalized MWCNT grown on stainless steel mesh was put in a clean vial and covered with 10 mL of deionised water. The particles were detached from the stainless steel substrate and dispersed by putting the vial in an ultrasonic bath. Ultrasonication can be performed during a period of about 10 minutes to up to 2 hours. The MWCNTs are broken off near their base, and not uprooted. Thus, the released MWCNTs are clean and do not contain the metal catalyst. The nanofluids are stable over an extended period of time.

The nanofluid's particle morphology, composition, absorbance and stability were analysed by scanning electron microscopy (SEM), scanning transmission electron microscopy (STEM), transmission electron microscopy (TEM), energy dispersive X-ray spectroscopy (EDS), X-ray photoelectron spectroscopy (XPS), UV/Vis/NIR absorbance spectroscopy and zeta potential measurements.

SEM, TEM, STEM and EDS

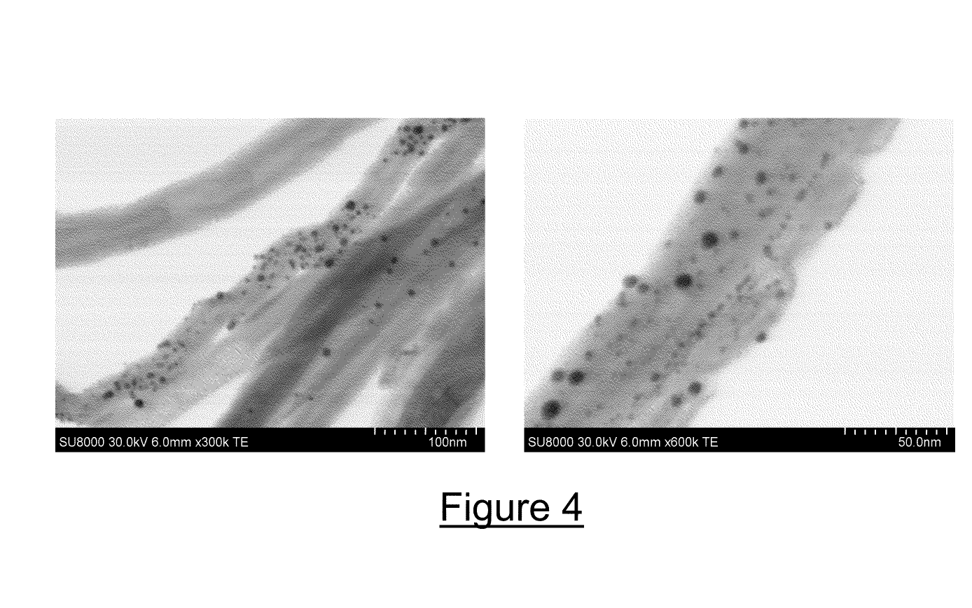

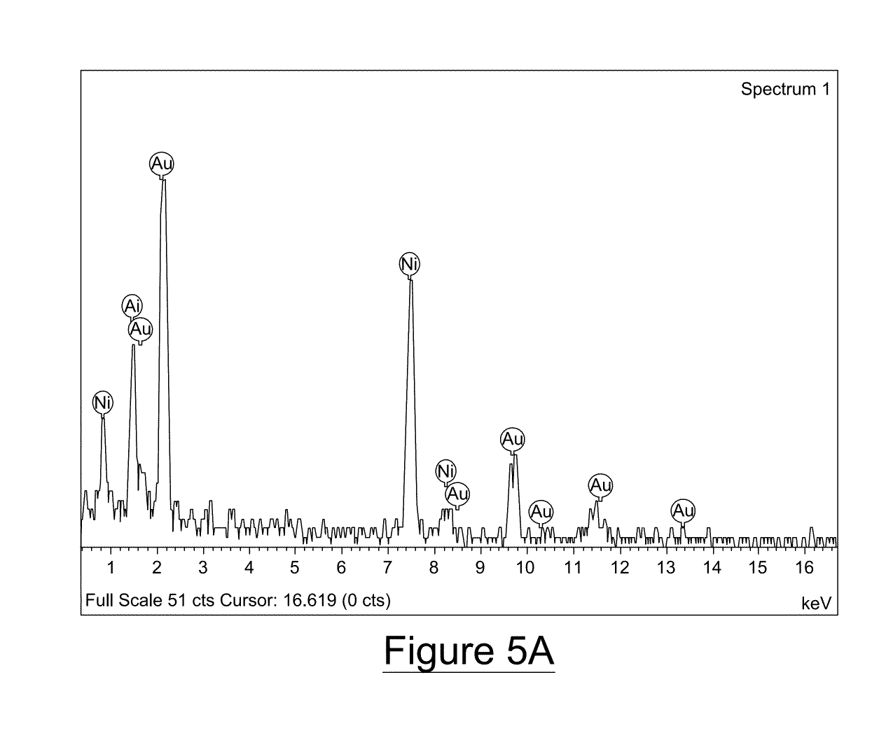

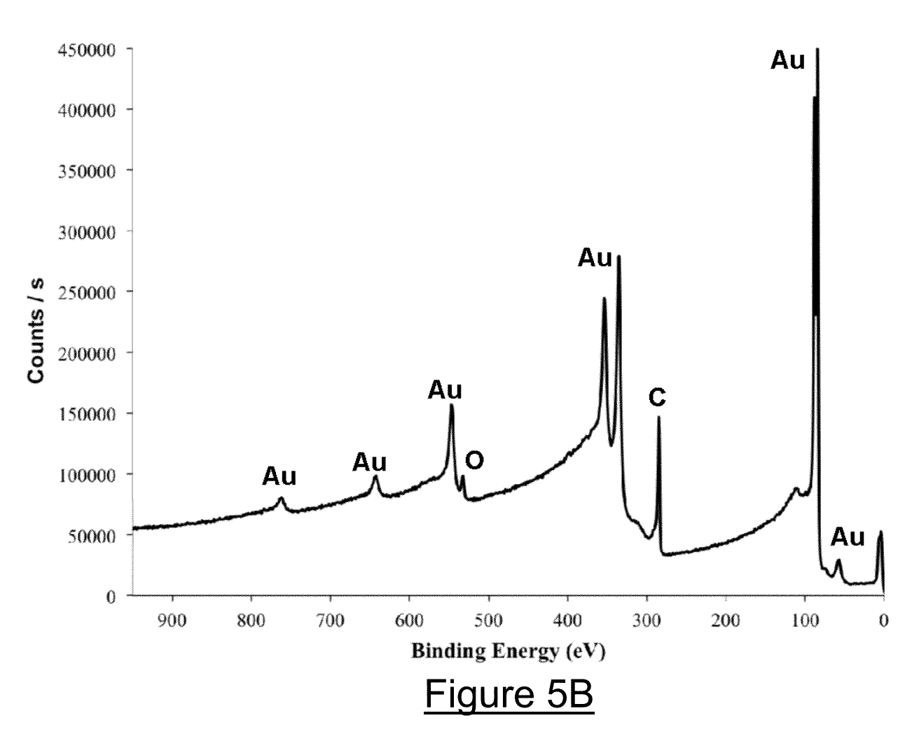

The MWCNTs were imaged both while attached to the substrate and after removal. In the case of post removal analysis, the nanofluid was either deposited onto a silicon substrate (SEM) or a TEM grid. In the case of FIG. 4, a drop of the Au NP-decorated oxygen-functionalized MWCNTs in water was deposited on a lacy carbon TEM grid. Since the nanofluid is a mixture of MWCNTs partly decorated with gold NPs, it is expected to find some MWCNT sections that are covered with gold NPs and others that are completely bare (see FIG. 4, left-hand side). The NPs covering the MWCNTs are 25 nm in diameter or less (see FIG. 4, right-hand side). EDS was performed on the NPs and revealed that they are made of gold (see FIG. 5A). The nickel peaks present in FIG. 5A originate from the support holding the TEM grid.

XPS

X-ray photoelectron spectroscopy was performed on the gold-decorated oxygen-functionalized MWCNTs (gold decoration level 300 sec). The XPS spectrum of FIG. 5B shows clear evidence of the gold nanoparticles, oxygen functionalities and MWCNTs.

UV-Vis Spectroscopy

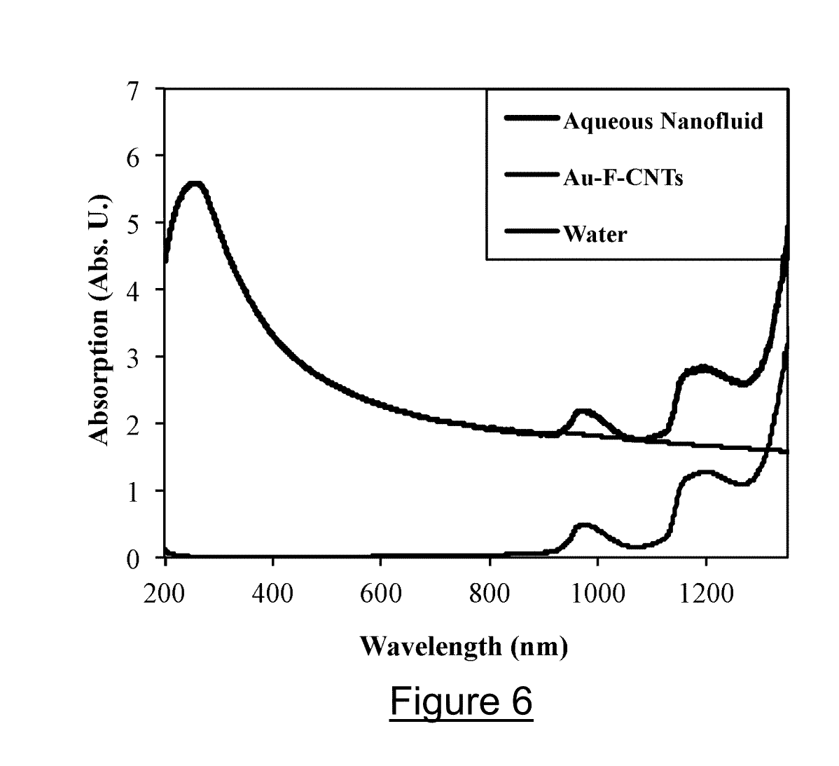

UV/visible/near infrared absorbance spectra of water, Au—F-MWCNTs (absorption due to water removed) and Au—F-MWCNTs nanofluid (with water) were recorded. The spectra show the typical broadband optical absorbance of MWCNTs, which peaks in the UV and gradually decreases towards the infrared (see FIG. 6). These results suggest that MWCNTs obtained are well-dispersed and not agglomerated. Due to the fact that the gold resonance band is absent, it suggests that the gold loading on the MWCNTs is very small and absorption by the MWCNTs is more intense (gold decoration level 300 sec).

Zeta Potential

To evaluate further the stability of the system, zeta potential measurements were taken for the Au—F-MWCNT aqueous nanofluid (gold decoration level 300 sec). Values around 38 mV (±2) were found, which indicates good stability of the MWCNTs and Au-decorated MWCNTs in the suspension.

Of course, numerous modifications could be made to the embodiments described above without departing from the scope of the present invention.

1. A nanofluid comprising a base fluid and multiwall carbon nanotubes (MWCNTs) dispersed in the base fluid, wherein the MWCNTs have an outer surface provided with polar functional groups, the outer surface having decorated portions covered with nanoparticles and undecorated portions where said polar functional groups are exposed.

2. The nanofluid of claim 1, wherein each of the MWCNTs has a diameter between about 15 and about 100 nm and/or the nanoparticles have a nanoparticle size between about 1 and about 60 nm.

3. The nanofluid of claim 1, wherein the MWCNTs have a diameter distribution characterized by a mean diameter ranging from about 30 to about 40 nm.

4. The nanofluid of claim 1 wherein the dispersed MWCNTs have a length distribution between about 100 nm and about 10 μm.

5. (canceled)

6. The nanofluid of claim 1, wherein the polar functional groups comprise oxygen-containing functional groups or nitrogen-containing groups.

7. The nanofluid of claim 6, wherein the oxygen-containing functional groups comprise carboxyl groups, carbonyl groups and hydroxyl groups, and the nitrogen-containing functional groups comprise amine groups and amide groups.

8. (canceled)

9. The nanofluid of claim 1, wherein the nanoparticles comprise metal, semiconductor or polymer nanoparticles.

10. The nanofluid of claim 1, wherein the nanoparticles comprise transition metal nanoparticles, cadmium selenide nanoparticles, polystyrene nanoparticles or polypyrrole nanoparticles.

11. The nanofluid of claim 1, wherein the nanoparticles comprise gold (Au), nickel (Ni), iron (Fe), chromium (Cr), cobalt (Co), copper (Cu), silver (Ag), titanium (Ti) or platinum (Pt) nanoparticles.

12. The nanofluid of claim 1, wherein the transition metal nanoparticles comprise gold nanoparticles.

13.-15. (canceled)

16. The nanofluid of claim 1, wherein the base fluid is water, deionized water, reverse osmosis water, ethylene glycol, propylene glycol, isopropanol, ethanol, methanol or denatured alcohol or any mixture thereof.

17.-18. (canceled)

19. The nanofluid of claim 1, wherein the MWCNTs are present in the nanofluid in a concentration of up to about 1 g/L, or in a concentration of up to about 0.150 g/L, or in a concentration of from about 0.005 to about 0.01 g/L.

20.-21. (canceled)

21. A method of preparation of a nanofluid, comprising the following steps:
growing MWCNTs on substrates by catalyst-free thermal chemical vapor deposition (t-CVD);
functionalizing an outer surface of the MWCNTs to form polar functional groups covalently bonded to the outer surface of the MWCNTs;
depositing nanoparticles on the outer surface of the MWCNTs such that the outer surface has decorated portions covered with the nanoparticles, while leaving undecorated portions where said polar functional groups are exposed, to form nanoparticle-decorated functionalized MWCNTs; and
detaching the nanoparticle-decorated functionalized MWCNTs from the substrates and dispersing thereof in a base fluid.

23. The method of claim 22, wherein the step of growing the MWCNTs by catalyst-free thermal chemical vapor deposition (t-CVD) comprises:
providing stainless steel substrates;
heating the substrates between about 650° C. to about 800° C.; and
exposing the substrates to acetylene whereby the MWCNTs are allowed to grow on the substrates.

24.-25. (canceled)

26. The method of claim 22, wherein the step of functionalizing the outer surface of the MWCNTs is performed by plasma-functionalization, by exposure of the MWCNTs to a radio-frequency glow discharge plasma using a Ar/C₂H₆/O₇ mixture or a Ar/C₂H₆/NH₃ mixture.

27.-28. (canceled)

29. The method of claim 22, wherein the step of depositing comprises deposition of metal nanoparticles on the outer surface of the MWCNTs by pulsed laser ablation or thermal evaporation/inert gas condensation.

30. (canceled)

31. The method of claim 29, wherein the step of depositing the nanoparticles on the outer surface of the MWCNTs is performed by exposing a transition metal, semiconductor, or polymer target facing the MWCNTs' surface to a pulsed laser beam.

32.-35. (canceled)

36. The method of claim 31, wherein the transition metal target is a gold target.

37. The method of claim 22, wherein the step of detaching and dispersing the nanoparticle-decorated functionalized MWCNTs in the base fluid is performed by ultrasonication.

38. The method of claim 22, wherein the base fluid is water, at least one polar organic solvent or a mixture of water and at least one polar organic solvent.

39.-52. (canceled)
